(19) United States
(12) Patent Application Publication
(10) Pub. No.: US 2026/0106813 A1
(43) Pub. Date: Apr. 16, 2026

(54) SYSTEMS AND METHODS FOR AUTOMATED VALIDATION OF NETWORK FUNCTION DEVICES

(71) Applicant: Verizon Patent and Licensing Inc., Basking Ridge, NJ (US)

(72) Inventors: Kejing Liu, Ashburn, VA (US); Krzysztof Pawlikowski, Farmington, CT (US); Byron V Eberle, Parkton, MD (US); Khurram Abbas, Novi, MI (US); Jaret B McMillan, Murfreesboro, TN (US)

(21) Appl. No.: 18/928,503

(22) Filed: Oct. 28, 2024

Related U.S. Application Data
(60) Provisional application No. 63/707,288, filed on Oct. 15, 2024.

(51) Int. Cl. H04L 43/065; H04L 43/045; H04L 43/16

(52) U.S. Cl. CPC H04L 43/065; H04L 43/045; H04L 43/16

(57) ABSTRACT

One or more computing devices, systems, and/or methods for validating Network Function (NF) devices are provided. In an example, a first NF device may be identified. The first NF device may be associated with a first validation status indicative of non-validated status. A service performance evaluation of the first NF device may be triggered. A second NF device may be selected for use in the service performance evaluation of the first NF device. The second NF device may be associated with a second validation status indicative of validated status. The service performance evaluation of the first NF device may be performed based upon a first service performance profile associated with the first NF device and a second service performance profile associated with the second NF device.

### RELATED APPLICATION

This application claims the benefit of U.S. Provisional Application No. 63/707,288, filed on Oct. 15, 2024, which is incorporated by reference herein in its entirety.

### BACKGROUND

Network function (NF) devices manage tasks like routing, switching, firewall protection, load balancing, and many other things in a network. Some NF devices may include hardware-based implementations, and some NF devices may be virtualized.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram illustrating a system for automatically validating Network Function (NF) devices, in accordance with some embodiments.

FIG. 2 is a diagram illustrating display of an evaluation report on a validation interface in accordance with some embodiments.

FIG. 3 is a flow chart illustrating a method for automatically validating NF devices, in accordance with some embodiments.

FIG. 4 is an illustration of an example environment in which at least a portion of the techniques presented herein may be utilized and/or implemented.

FIG. 5 is an illustration of an example network that may utilize and/or implement at least a portion of the techniques presented herein.

FIG. 6 is an illustration of a scenario featuring an example non-transitory machine-readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for automated validation of Network Function (NF) devices are provided. In some examples, a validation system may include an NF device discovery module that monitors (e.g., continuously and/or periodically monitors) network activity of one or more networks and/or detects an addition of a first NF device to a network of the one or more networks based upon the (monitored) network activity. The validation system may determine that the first NF device has not been successfully validated since the first NF device was added to the network. In response to identifying the first NF device and/or determining that the first NF device is associated with a non-validated status, the validation system may trigger a service performance evaluation for the first NF device. A second NF device (e.g., validated NF device) and/or a plurality of NF devices may be selected for use in the service performance evaluation of the first NF device. The service performance evaluation of the first NF device may be performed based upon a first service performance profile associated with the first NF device and a second service performance profile associated with the second NF device. In response to performing the service performance evaluation, the validation system may update a validation status of the first NF device based upon an evaluation result of the service performance evaluation, and/or may provide a notification indicative of the evaluation result to a network management agent. In an example in which the service performance evaluation resulted in a positive evaluation result (that indicates the first NF device is successfully validated), the validation status of the first NF device may be updated from non-validated status to validated states

In accordance the present disclosure, the validation system may automatically (and/or without additional intervention) (i) discover the first NF device, (ii) trigger and/or perform the service performance evaluation for the first NF device, and/or (iii) provide a notification indicative of the evaluation result to the network management agent. In this way, the validation system may provide for automated discovery and/or validation in response to activating the first NF device and/or connecting the first NF device to a network, thereby reducing or eliminating additional efforts required to trigger validation of the first NF device after activating the first NF device and/or connecting the first NF device to the network. Accordingly, the validation system may provide for “plug and play” functionality and/or seamless validation of the first NF device in response to the first NF device being activated and/or connected to the network.

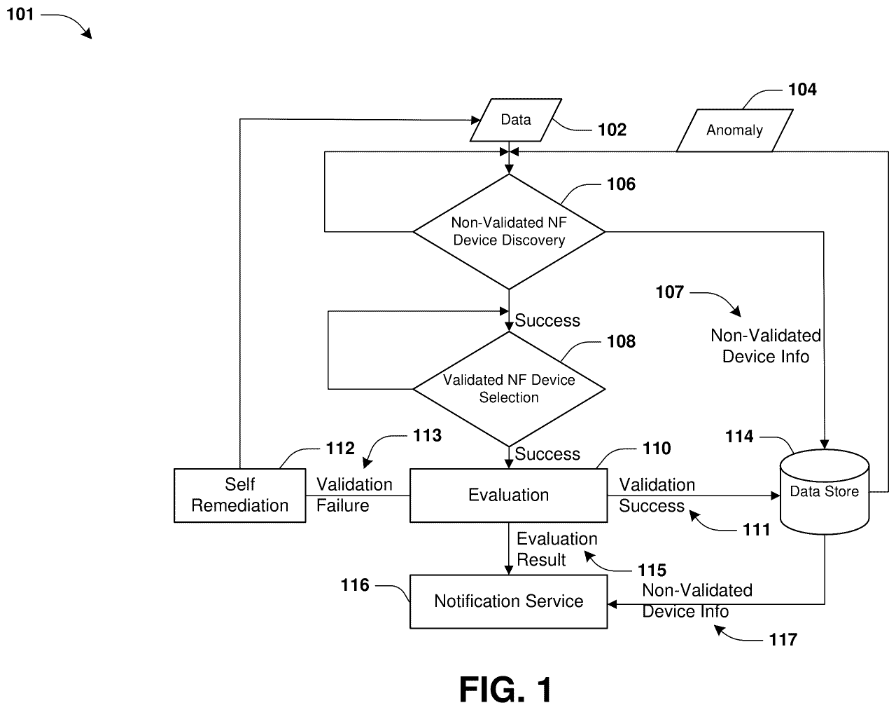

FIG. 1 illustrates an example of a validation system 101 (e.g., automated validation system) for NF device validation (e.g., automated NF device validation). In some examples, the validation system 101 comprises a NF device discovery module 106 (e.g., a non-validated NF device discovery module). The NF device discovery module 106 is configured to identify one or more non-validated NF devices of a network. In some examples, the NF device discovery module 106 is configured to access, generate and/or maintain a NF data structure (e.g., a list, an array, etc.) indicative of a set of non-validated NF devices (e.g., a set of one or more non-validated NF devices) and/or a set of validated NF devices (e.g., a set of one or more validated NF devices). In some examples, a non-validated NF device of the set of non-validated NF devices is associated with a validation status indicative of non-validated status (e.g., False). In some examples, a validated NF device of the set of non-validated NF devices is associated with a validation status indicative of validated status (e.g., True). In some examples, the NF data structure is stored in a data store 114 (e.g., a database) of the validation system 101.

In some examples, the set of non-validated NF devices includes one or more previously unknown and/or newly discovered NF devices. In some examples, the NF device discovery module 106 is configured to (i) monitor (e.g., continuously and/or periodically monitor) network activity of one or more networks, and/or (ii) detect an addition of a first NF device to a network of the one or more networks based upon the (monitored) network activity (e.g., the NF device discovery module 106 may detect network signals being transmitted and/or received by a new and/or unknown device). In some examples, after the first NF device is added to the network, the first NF device may be active, operational, and/or at least partially integrated into the network. In some examples, the first NF device is used to handle live traffic and/or communication of the network.

When NF devices (e.g., the first NF device and/or other NF devices) is integrated into the network, one or more monitoring platforms of the NF device discovery module 106 may ingest KPIs from the NF devices as they are instantiated. In some examples, the NF device discovery module 106 may automatically ingest and/or monitor new KPIs as they appear. In some examples, upon detecting an NF device (e.g., the first NF device) that the NF device discovery module 106 has not seen before, the NF device discovery module 106 may treat the NF device as a new NF device.

In some examples, in response to detecting the first NF device, the NF device discovery module 106 may (i) set a first validation status associated with the first NF device to non-validated status and/or (ii) update the NF data structure to include an indication of the first NF device and/or the first validation status. In some examples, the NF device discovery module 106 may set the first validation status associated with the first NF device to non-validated status based upon a determination that the first NF device was not successfully validated since the addition of the first NF device to the network.

Alternatively, and/or additionally, the set of non-validated NF devices may include one or more flagged NF devices. In some examples, the one or more flagged NF devices comprise a second (flagged) NF device flagged by the NF device discovery module 106 for a service performance issue. In some examples, the second NF device may have previously underwent an evaluation and/or was successfully validated prior to being flagged for the service performance issue. In some examples, the second NF device may be associated a second validation status. In some examples, the NF device discovery module 106 may monitor network activity associated with the second NF device and/or may flag the second NF device for the service performance issue in response to identifying the service performance issue based upon the network activity. In some examples, the second validation status may be indicative of validated status after the second NF device was successfully validated and prior to being flagged for the service performance issue.

In some examples, the NF device discovery module 106 may facilitate one or more first corrective actions to address (e.g., solve) the service performance issue. The one or more first corrective actions may comprise one or more actions to improve service performance associated with the second NF device. For example, the one or more first corrective actions may comprise allocating resources (e.g., increased resources), such as at least one of manpower, a maintenance device, energy (e.g., increased power for increased transmit power), one or more spectrums, equipment, one or more antennas, etc. to the second NF device to address (e.g., solve) the service performance issue. Alternatively, and/or additionally, the one or more first corrective actions may comprise (i) modifying network resources associated with the second NF device (e.g., allocating a new set of network resources for use by the second NF device), (ii) switching a network slice assigned to the second NF device (e.g., switching a network slice assigned to the second NF device from a first network slice to a second network slice), (iii) modifying one or more Quality of Service (QoS) parameters associated with the second NF device (e.g., increasing QoS level assigned to the second NF device), (iv) modifying a priority of traffic of the second NF device (e.g., increasing a priority of traffic of the second NF device to prioritize the traffic over other traffic), (v) deploying one or more resources to the second NF device, (vi) reconfiguring, repairing and/or replacing one or more components (e.g., malfunctioning components) of the second NF device, (vii) performing a software update for the second NF device, and/or (viii) transmitting information, associated with the second NF device, to a network maintenance device associated with a network maintenance agent (e.g., a person, a robot, etc. tasked with repairing and/or performing maintenance for malfunctioning network components). The network maintenance agent may use the information to (i) repair, reconfigure and/or replace one or more malfunctioning components of the first region of interest and/or (ii) perform one or more other actions. Accordingly, in some examples, the one or more first corrective actions may improve service performance of the second NF device, and thus may address (e.g., solve) the service performance issue.

In some examples, the NF device discovery module 106 may set the second validation status associated with the second NF device to non-validated status (e.g., the second validation status is updated from being indicative of validated status to being indicative of non-validated status) based upon the service performance issue. For example, the NF device discovery module 106 may set the second validation status associated with the second NF device to non-validated status in response to identifying the service performance issue and/or flagging the second NF device for the service performance issue. Alternatively, and/or additionally, the NF device discovery module 106 may set the second validation status associated with the second NF device to non-validated status in response to performing and/or facilitating the one or more first corrective actions. In some examples, the NF device discovery module 106 may set the second validation status associated with the second NF device to non-validated status based upon a determination that the second NF device was not successfully validated since the second NF device was flagged for the service performance issue and/or the one or more first corrective actions were performed. In some examples, the NF device discovery module 106 may update the NF data structure to include an indication of the second NF device and/or the second validation status indicative of the non-validated status.

In some examples, the NF device discovery module 106 may trigger and/or perform a service performance evaluation for a third (non-validated) NF device of the set of non-validated NF devices indicated by the NF data structure. In an example, the third NF device may comprise the first NF device (e.g., newly discovered NF device), the second NF device (e.g., flagged and/or repaired NF device) and/or a different NF device of the set of non-validated NF devices. In some examples, the third NF device is associated with a third validation status indicative of non-validated status.

In some examples, the NF device discovery module 106 may trigger and/or perform the service performance evaluation for the third NF device in response to a determination that the third NF device is ready for evaluation. For example, the NF device discovery module 106 may determine whether the third NF device is ready for evaluation based upon a third service performance profile associated with the third NF device. In some examples, the NF data structure comprises the third performance profile. In some examples, the third service performance profile is indicative of network activity (e.g., transmissions and/or receptions between the third NF device and other components of a network to which the third NF device is connected) and/or a first set of service performance indicators (e.g., a set of one or more key performance indicators (KPIs)) associated with the third NF device. In some examples, the first set of service performance indicators may be determined based upon the network activity of the third NF device. The network activity of the third NF device may be performed during a first period of time. In some examples, a duration of the first period of time may be set to a first duration (e.g., one or more minutes, one or more hours, one or more days, etc.). In an example in which the first duration is three days, the first period of time may be a period of about three days (e.g., the first set of service performance indicators may be derived from network activity performed using the third NF device over the period of three days).

In some examples, the validation system 101 comprises a data module 102 to retrieve (from the data store 114, for example) and/or hold service performance indicators (e.g., relevant time series KPIs), such as the first set of service performance indicators associated with the third NF device and/or other service performance indicators associated with other NF devices (e.g., other NF devices being validated and/or validated NF devices being used to validate a non-validated NF device). In some examples, the NF device discovery module 106 may retrieve the first set of service performance indicators from the data module 102.

In some examples, the NF device discovery module 106 may determine that the third NF device is ready for evaluation based upon (i) a determination that a first traffic volume metric associated with the third NF device meets (e.g., exceeds) a first threshold traffic volume metric and/or (ii) a determination that the third NF device is associated with normalized service performance. For example, the NF device discovery module 106 may (i) determine the first traffic volume metric based upon the third service performance profile (e.g., the first traffic volume metric may be indicated by the first set of service performance indicators) and/or (ii) compare the first traffic volume metric with the first threshold traffic volume metric to determine whether the first traffic volume metric meets (e.g., exceeds) the first threshold traffic volume metric. Alternatively, and/or additionally, the NF device discovery module 106 may determine that the third NF device is ready for evaluation based upon a determination that (i) the third NF device has been connected to the network for longer than the first duration, (ii) the third NF device has been active for longer than the first duration, and/or (iii) there is sufficient data available for the third NF device (e.g., in an example in which the first duration is 3 days, the third service performance profile may be deemed to comprise sufficient data for the service performance evaluation based upon the third service performance profile comprising data associated with at least 3 days of network activity of the third NF device).

In some examples, the NF device discovery module 106 may determine whether the third NF device is associated with normalized service performance based upon a first normalized service performance indicator (e.g., a performance KPI) of the first set of service performance indicators. In some examples, the validation system 101 may comprise a anomaly detection module 104 to (i) determine (based upon the third service performance profile, for example) whether the third NF device is associated with normalized behavior or is associated with anomalous behavior and/or (ii) generate the first normalized service performance indicator based upon the determination of whether the third NF device is associated with normalized behavior or is associated with anomalous behavior. The first normalized service performance indicator may be set to a first value to indicate that the third NF device is associated with normalized service performance. In some examples, the anomaly detection module 104 may determine that the third NF device is associated with normalized service performance (and/or may set the first normalized service performance indicator to the first value) in response to (i) a determination (e.g., a determination based upon the third service performance profile) that the third NF device is not associated with an ongoing service performance issue (e.g., an ongoing service performance issue may be a service performance issue that is currently impacting the third NF device) and/or (ii) a determination (e.g., a determination based upon the third service performance profile) that the third NF device is not associated with anomalous behavior (e.g., one or more service performance indicators of the first set of service performance indicators do not deviate from what is normal and/or expected from the third NF device). In some examples, the anomaly detection module 104 may determine that the third NF device is not associated with normalized service performance (and/or may set the first normalized service performance indicator to the second value) in response to (i) a determination (e.g., a determination based upon the third service performance profile) that the third NF device is associated with an ongoing service performance issue and/or (ii) a determination (e.g., a determination based upon the third service performance profile) that the third NF device is associated with anomalous behavior (e.g., one or more service performance indicators of the first set of service performance indicators deviate from what is normal and/or expected from the third NF device).

In some examples, the third NF device is discovered by the NF device discovery module 106 at a time t1. In response to discovering the third NF device, the NF device discovery module 106 may (i) store an indication of the third NF device in the NF data structure, (ii) store a first timestamp corresponding to the time t1 in the NF data structure and/or (iii) set the third validation status to be indicative of non-validated status (e.g., False). In some examples, in response to discovering the third NF device, the NF device discovery module 106 may determine one or more traffic volume metrics associated with the third NF device (e.g., the first traffic volume metric and/or other traffic volume metrics) and/or compare the one or more traffic volume metrics with the first threshold traffic volume metric. In an example, the one or more traffic volume metrics may comprise at least one of a traffic volume metric (e.g., hourly traffic volume metric, daily traffic volume metric, etc.) for a second period of time (e.g., an hour, a day, etc.), a traffic volume metric (e.g., hourly traffic volume metric, daily traffic volume metric, etc.) for a third period of time (e.g., an hour, a day, etc.) after the second period of time, etc. In some examples, in response to determining that the one or more traffic volume metrics meet the first threshold traffic volume metric (e.g., traffic volume metrics associated with the third NF device consistently meet the first threshold traffic volume metric for at least a first threshold duration), the NF device discovery module 106 may (i) determine a second timestamp corresponding to a time t2 (e.g., a time associated with the determination that the one or more traffic volume metrics meet the first threshold traffic volume metric) and/or (ii) trigger the anomaly detection module 104 of the validation system 101 to determine (based upon the third service performance profile, for example) whether the third NF device is associated with normalized behavior or is associated with anomalous behavior.

In an example, the anomaly detection module 104 maintains an anomaly data structure indicative of anomalies associated with NF devices such as the third NF device. In some examples, the anomaly detection module 104 may analyze the anomaly data structure to look for and/or identify one or more anomalies, associated with the third NF device, after the time t2 indicated by the second timestamp. An anomaly of the one or more anomalies may correspond to anomalous behavior of the third NF device, such as unexpected and/or atypical traffic patterns (e.g., traffic spike, traffic drop, unusual traffic routes, irregular data patterns, etc.), unexpected and/or atypical latency, unexpected and/or atypical resource consumption, unexpected and/or atypical rebooting, etc. In some examples, in response to identifying the one or more anomalies associated with the third NF device, the anomaly detection module 104 may determine a time t3 associated with the one or more anomalies (e.g., the time t3 may correspond to a latest timestamp of a most recent anomaly of the one or more anomalies). In some examples, the anomaly detection module 104 may determine that the third NF device is associated with anomalous behavior (and/or is not associated with normalized behavior) based upon (i) a determination that the time t3 is a current time or is within a second threshold duration (e.g., 5 minutes, 10 minutes, 1 hour, etc.) of the current time (e.g., if the second threshold duration is 5 minutes, the anomaly detection module 104 may determine that the third NF device is associated with anomalous behavior based upon the time t3 being later than 5 minutes before the current time), and/or (ii) a determination that data available for the time t3 is the most recent data collected on the third NF device. In some examples, the anomaly detection module 104 may determine that the third NF device is not associated with anomalous behavior (and/or is associated with normalized behavior) based upon (i) a determination that the time t3 is before the current time (and/or the time t3 is before the current time by at least the second threshold duration) and/or (ii) a determination that data available for the time t3 is historical data collected on the third NF device (and/or the data available for the time t3 is not the most recent data collected on the third NF device).

In some examples, the NF device discovery module 106 may not trigger and/or perform the service performance evaluation for the third NF device based upon a determination that the third NF device is not ready for evaluation. The NF device discovery module 106 may determine that the third NF device is not ready for evaluation based upon the first traffic volume metric associated with the third NF device not meeting (e.g., being less than) the first threshold traffic volume metric and/or the third NF device not being associated with normalized service performance (e.g., the third NF device is associated with anomalous behavior and/or an ongoing service performance issue). Alternatively, and/or additionally, the NF device discovery module 106 may determine that the third NF device is not ready for evaluation based upon a determination that (i) the third NF device has been connected to the network for less than the first duration, (ii) the third NF device has been active for less than the first duration, and/or (iii) there is insufficient data available for the third NF device (e.g., in an example in which the first duration is 3 days, the third service performance profile may be deemed to comprise insufficient data for the service performance evaluation based upon the third service performance profile comprising data associated with less than 3 days of network activity of the third NF device). In some examples, the NF device discovery module 106 may postpone triggering and/or performing the service performance evaluation until a later time (after it is determined that the third NF device is ready for evaluation, for example). For example, the NF device discovery module 106 may include the third NF device in an evaluation waitlist in response to determining that the third NF device is not ready for evaluation. In some examples, while the third NF device is in the evaluation waitlist, the NF device discovery module 106 may (i) check (e.g., periodically check once per day, once per hour, or at a different rate) whether the third NF device is ready for evaluation, and/or (ii) trigger the service performance evaluation for the third NF device in response to determining that the third NF device is ready for evaluation.

In some examples, in response to determining that the third NF device is not ready for evaluation, the NF device discovery module 106 may store information 107 associated with the third NF device in the data store 114 (e.g., the NF device discovery module 106 may update the third service performance profile to include the information 107). The information 107 may comprise (i) an indication (e.g., a hostname) of the third NF device, (ii) an indication that the third NF device is not ready for evaluation, (iii) one or more service performance indicators (e.g., at least one of the first traffic volume metric, the first normalized service performance indicator, etc.) associated with the third NF device, (iv) one or more service performance indicators (e.g., at least one of the first traffic volume metric, the first normalized service performance indicator, etc.) associated with the third NF device (v) a timestamp of when the third NF device was discovered by the NF device discovery module 106 and/or a timestamp associated with the addition of the first NF device to the network.

In some examples, the NF device discovery module 106 may trigger and/or perform the service performance evaluation for the third NF device in response to (i) a determination that the first traffic volume metric associated with the third NF device meets (e.g., exceeds) the first threshold traffic volume metric and/or (ii) a determination that the third NF device is associated with normalized service performance.

In some examples, the service performance evaluation comprises a comparative evaluation between service performance of the third NF device and service performance of one or more validated NF devices (e.g., one or more existing NF devices). In some examples, the validation system 101 comprises a validated NF device selection module 108. The validated NF device selection module 108 is configured to select a first validated NF device for use in the service performance evaluation (e.g., the first validated NF device is selected for comparison with the third NF device). In some examples, the first validated NF device is associated with a fourth validation status indicative of validated status. In some examples, the NF data structure may be indicative of the first validated NF device and/or the fourth validation status.

In some examples, the validated NF device selection module 108 may select the first validated NF device (for use in the service performance evaluation) from a set of candidate NF devices. In some examples, the set of candidate NF devices may comprise one, some or all of the set of validated NF devices indicated by the NF data structure. In some examples, the validated NF device selection module 108 may select the first validated NF device (for use in the service performance evaluation) based upon the third service performance profile associated with the third NF device and/or a set of service performance profiles associated with the set of candidate NF devices. In some examples, the NF data structure comprises the set of service performance profiles, which may comprise a fourth service performance profile associated with the first validated NF device.

In some examples, the validated NF device selection module 108 may select the first validated NF device (for use in the service performance evaluation) based upon a determination that the first validated NF device is within a proximity of the third NF device. For example, the validated NF device selection module 108 may (i) determine a first geolocation associated with the third NF device (e.g., the first geolocation may be indicated by the third service performance profile), (ii) determine a second geolocation associated with the first validated NF device (e.g., the second geolocation may be indicated by the fourth service performance profile), and/or (iii) determine whether the first validated NF device is within a proximity of the third NF device based upon the first geolocation and/or the second geolocation. In some examples, the first geolocation may be indicative of a first geographical area (e.g., a first city, a first neighborhood, a first zip code, a first county, a first telecommunication territory, etc.) and/or the second geolocation may be indicative of a second geographical area (e.g., a second city, a second neighborhood, a second zip code, a second county, a second telecommunication territory, etc.). The validated NF device selection module 108 may determine that the first validated NF device is within a proximity of the third NF device based upon a determination that (i) the first geographical area matches the second geographical area (e.g., the first zip code and the second zip code are both the same zip code), (ii) the first geographical area at least partially overlaps with the second geographical area, and/or (iii) the first geographical area is within a threshold distance of the second geographical area. In some examples, the first geolocation may be indicative of a first set of coordinates associated with the third NF device (e.g., latitude and/or longitude coordinates determined using satellite navigation) and/or the second geolocation may be indicative of a second set of coordinates associated with the first validated NF device (e.g., latitude and/or longitude coordinates). The validated NF device selection module 108 may determine that the first validated NF device is within a proximity of the third NF device based upon a determination that a location corresponding to the first set of coordinates is within a threshold distance of a location corresponding to the second set of coordinates.

In some examples, the validated NF device selection module 108 may select the first validated NF device (for use in the service performance evaluation) based upon (i) a determination that a second traffic volume metric associated with the first validated NF device meets (e.g., exceeds) a second threshold traffic volume metric (which may be the same as or different than the first threshold traffic volume metric) and/or (ii) a determination that the first validated NF device is associated with normalized service performance. For example, the second traffic volume metric may be determined based upon one or more service performance indicators indicated by the fourth service performance profile.

In some examples, the validated NF device selection module 108 may determine whether the first validated NF device is associated with normalized service performance based upon a second normalized service performance indicator (e.g., a performance KPI) indicated by the fourth service performance profile. In some examples, the anomaly detection module 104 may (i) determine (based upon the fourth service performance profile, for example) whether the first validated NF device is associated with normalized behavior or is associated with anomalous behavior and/or (ii) generate the second normalized service performance indicator based upon the determination of whether the first validated NF device is associated with normalized behavior or is associated with anomalous behavior. The second normalized service performance indicator may be set to the first value to indicate that the first validated NF device is associated with normalized service performance. In some examples, the anomaly detection module 104 may determine whether the first validated NF device is associated with normalized service performance (and/or may set the second normalized service performance indicator to the first value or the second value) using one or more of the techniques provided herein with respect to determining whether the third NF device is associated with normalized service performance and/or determining the first normalized service performance indicator associated with the third NF device. In some examples, the anomaly detection module 104 may determine that the first validated NF device is associated with normalized service performance (and/or may set the second normalized service performance indicator to the first value) in response to (i) a determination that the first validated NF device is not associated with an ongoing service performance issue, (ii) a determination (e.g., a determination based upon the fourth service performance profile) that the first validated NF device is not associated with anomalous behavior during a time window (e.g., one or more service performance indicators indicated by the fourth service performance profile do not deviate from what is normal and/or expected from the first validated NF device) and/or (iii) a determination (e.g., a determination based upon the fourth service performance profile) that the first validated NF device is not associated consistent anomalies during the time window.

In some examples, the validated NF device selection module 108 may select the first validated NF device (for use in the service performance evaluation) based upon a determination that traffic volume levels of the first validated NF device and the third NF device are comparable. In some examples, the validated NF device selection module 108 may determine that traffic volume levels of the first validated NF device and the third NF device are comparable based upon a determination that a difference between a traffic volume metric (e.g., the first traffic volume metric) associated with the third NF device and a traffic volume metric (e.g., the second traffic volume metric) associated with the first validated NF device is less than a threshold difference.

In some examples, the validated NF device selection module 108 may select the first validated NF device (for use in the service performance evaluation) based upon a determination that traffic patterns of the first validated NF device and the third NF device are comparable. In some examples, the validated NF device selection module 108 may (i) determine a first set of traffic data associated with network activity of the third NF device (e.g., the first set of traffic data may be determined based upon the third service performance profile and/or may be indicative of one or more service performance indicators associated with the third NF device over one or more times), (ii) determine a second set of traffic data associated with network activity of the first validated NF device (e.g., the second set of traffic data may be determined based upon the fourth service performance profile and/or may be indicative of one or more service performance indicators associated with the first validated NF device over one or more times), (iii) compare the first set of traffic data with the second set of traffic data to determine a first similarity score indicative of a similarity between traffic patterns of the first validated NF device and the third NF device, and/or (iv) determine whether traffic patterns of the first validated NF device and the third NF device are comparable based upon the first similarity score. In some examples, the validated NF device selection module 108 may determine that traffic patterns of the first validated NF device and the third NF device are comparable based upon a determination that the first similarity score meets (e.g., exceeds) a threshold similarity score.

In some examples, the validated NF device selection module 108 may select the first validated NF device (for use in the service performance evaluation) based upon a determination that a first NF device type of the third NF device matches a second NF device type of the first validated NF device. In an example, the first NF device type and/or the second NF device type may comprise (i) 5G Core Network (5GC) device type (e.g., at least one of Session Management Function (SMF) device, User Plane Function (UPF) device, Access and Mobility Management Function (AMF) device, etc.) (ii) LTE Evolved Packet Core (EPC) device type (e.g., at least one of Packet Data Network Gateway (PGW) device, Serving Gateway (SGW) device, Mobility Management Entity (MME) device, etc.), (iii) Transport device type (e.g., at least one of Border Leaf, Access Leaf, Spine Router, Ethernet Backhaul Multi-Layer Service (EBH MLS) Router, etc.), and/or (iv) Radio Access Network (RAN) device type (e.g., at least one of Next Generation NodeB (gNB), Evolved NodeB (eNB), etc.). In an example, the validated NF device selection module 108 may determine that the first NF device type matches the second NF device type based upon a determination that the first NF device type and the second NF device type are both 5GC device type.

In some examples, the validated NF device selection module 108 may analyze the set of service performance profiles (associated with the set of candidate NF devices) to identify one or more validated NF devices that satisfy a set of conditions (e.g., a set of one or more conditions) comprising at least one of (i) a condition that the NF device is associated with a validation status indicative of validated status, (ii) a condition that the NF device is within a proximity of the third NF device, (iii) a condition that a traffic volume metric associated with the NF device meets the second threshold traffic volume metric, (iv) a condition that the NF device is associated with normalized service performance, (v) a condition that traffic volume levels of the NF device and the third NF device are comparable, (vi) a condition that traffic patterns of the NF device and the third NF device are comparable, (vii) a condition that a device type of the NF device matches the first NF device type of the third NF device, and/or (viii) one or more other conditions. In some examples, in response to identifying a plurality of candidate NF devices that satisfy the set of conditions, the validated NF device selection module 108 may (i) determine candidate scores associated with the plurality of candidate NF devices based upon at least one of proximity of the plurality of candidate NF devices to the third NF device, difference between a traffic volume of the plurality of candidate NF devices relative to traffic volume of the third NF device, similarity of traffic patterns of the plurality of candidate NF devices relative to traffic patterns of the third NF device, etc., (ii) rank the plurality of candidate NF devices based upon the candidate scores, and/or (iii) select one or more highest-ranked NF devices (e.g., the first validated NF device) from the plurality of candidate NF devices for use in the service performance evaluation.

In some examples, in response to determining that the set of candidate NF devices does not comprise a validated NF device that satisfies the set of conditions, the validated NF device selection module 108 may modify the set of candidate NF devices from an initial set of candidate NF devices to a modified (e.g., new and/or expanded) set of candidate NF devices. In some examples, the modified set of candidate NF devices includes candidate NF devices of a larger geographical area than the initial set of candidate NF devices. In an example, the initial set of candidate NF devices may comprise NF devices within a first geographical area (e.g., a town where the third NF device is located) and/or the modified set of candidate NF devices may comprise NF devices within a second geographical area (e.g., a territory, county, state and/or province that may encompass at least a portion of the town) that is larger than the first geographical area. In some examples, the set of candidate NF devices may be modified (e.g., expanded) one or more iterations until one or more candidate NF devices are found that satisfy the set of conditions. In some examples, in response to a determination that a candidate NF device that satisfies the set of conditions is not available, the validated NF device selection module 108 may postpone performing the service performance evaluation until a later time (after a validated NF device that satisfies the set of conditions becomes available for use in the service performance evaluation, for example).

In an example, groupings of datacenter locations of varying sizes may comprise at least one of a submarket, market, territory, etc. NF devices inside these datacenters cover a given geographic area. In an example, the initial set of candidate NF devices may comprise NF devices within a first submarket and/or the modified set of candidate NF devices may comprise NF devices within a first market comprising the first submarket (and/or one or more other submarkets). Alternatively and/or additionally, the initial set of candidate NF devices may comprise NF devices within the first market and/or the modified set of candidate NF devices may comprise NF devices within a first territory comprising the first market (and/or one or more other markets).

In some examples, the validation system 101 may comprise an evaluation module 110 configured to perform the service performance evaluation of the third NF device. In some examples, the evaluation module 110 may perform the service performance evaluation in response to receiving a request (from the validated NF device selection module 108, for example) comprising (i) an indication (e.g., a hostname) of the third NF device, (ii) an indication (e.g., a hostname) of the first validated NF device and/or (iii) an indication of the time window (e.g., a comparative time window of the service performance evaluation) of network activity to be compared. In some examples, the time window may be set to the first duration (e.g., 3 days or other duration of time) or a different duration. In some examples, the validation system 101 may determine a start time (t_start) of the time window based upon the time t2 and/or the time t3. For example, the start time may be set to t_start=t2+timedelta1 or t_start=t3+timedelta1, wherein timedelta1 may be a first predefined value (e.g., one or more minutes, one or more hours, one or more days, etc.). Alternatively, and/or additionally, the validation system 101 may determine an end time of the time window (t_end) based upon the start time t_start. For example, the end time may be set to t_end=t_start+timedelta2, wherein timedelta2 may be a second predefined value (e.g., one or more days). In an example, the second predefined value timedelta2 may be set to the first duration or a different duration.

In some examples, the validated NF device selection module 108 may select the first validated NF device (for use in the service performance evaluation) based upon network activity of the first validated NF device during the time window (e.g., the validated NF device selection module 108 may use service performance metrics that are indicative of network activity within the time window to select the first validated NF device for use in the service performance evaluation).

The evaluation module 110 may perform the service performance evaluation based upon the third service performance profile associated with the third NF device and/or the fourth service performance profile associated with the first validated NF device. In some examples, the service performance evaluation may comprise a comparative analysis of network activity of the third NF device during the time window with network activity of the first validated NF device during the time window. For example, the service performance evaluation may comprise comparing a second set of service performance indicators (e.g., a second set of one or more service performance indicators) indicated by the third service performance profile with a third set of service performance indicators (e.g., a third set of one or more service performance indicators) indicated by the fourth service performance profile. In some examples, the second set of performance indicators and the third set of service performance indicators are associated with the time window. For example, the second set of performance indicators may be derived from (and/or indicative of) network activity of the third NF device during the time window. Alternatively, and/or additionally, the third set of performance indicators may be derived from (and/or indicative of) network activity of the first validated NF device during the time window. In some examples, the service performance evaluation may comprise a Kolmogorov-Smirnov test (and/or other type of test) performed using the second set of performance indicators and/or the third set of service performance indicators.

In some examples, the service performance evaluation may be performed based upon the first NF device type associated with the third NF device. In some examples, the evaluation module 110 may select an evaluation program from a plurality of evaluation programs associated with a plurality of NF device types. In some examples, the evaluation module 110 may select and/or execute a first evaluation program (of the plurality of evaluation programs) to perform the service performance evaluation based upon a determination that a device type associated with the first evaluation program matches the first NF device type. Alternatively, and/or additionally, the evaluation module 110 may select and/or execute a second evaluation program (of the plurality of evaluation programs) to perform the service performance evaluation based upon a determination that a device type associated with the second evaluation program matches the first NF device type.

In an example, for each service performance indicator of one, some or all of the second set of service performance indicators, the evaluation module 110 may (i) compare the service performance indicator with a reference service performance indicator of the third set of service performance indicators to determine a difference between the service performance indicator and the reference service performance indicator, and/or (ii) determine, based upon the difference, a comparison result indicative of whether the difference between the service performance indicator and the reference service performance indicator is potentially problematic (e.g., indicative of a potential service performance issue). In an example, the evaluation module 110 may compare the difference with a threshold difference, and/or determine whether the difference is potentially problematic based upon whether the difference meets the threshold difference. Alternatively, and/or additionally, the evaluation module 110 may (i) perform the Kolmogorov-Smirnov test (and/or other type of test) based upon the service performance indicator and the reference service performance indicator to determine a first probability that the service performance indicator is significantly different from the reference service performance indicator and/or (ii) compare the first probability with a threshold probability, and/or (iii) determine whether the difference between the service performance indicator and the reference service performance is potentially problematic based upon whether the first probability meets the threshold probability.

In an example, the evaluation module 110 may (i) compare a traffic volume metric (e.g., the first traffic volume metric) of the second set of service performance indicators with a reference traffic volume metric (e.g., the second traffic volume metric) of the third set of service performance indicators to determine a traffic volume difference, and/or (ii) determine, based upon the traffic volume difference, a first comparison result indicative of whether the traffic volume difference is potentially problematic. In an example, the evaluation module 110 may determine that the traffic volume difference is potentially problematic based upon a determination that the traffic volume difference meets (e.g., exceeds) a threshold traffic volume difference. In an example, the evaluation module 110 may determine that the traffic volume difference is not potentially problematic based upon a determination that the traffic volume difference does not meet (e.g., is less than) the threshold traffic volume difference. Alternatively, and/or additionally, the evaluation module 110 may (i) compare an error rate indicated by the second set of service performance indicators with a reference error rate indicated by the third set of service performance indicators to determine an error rate difference, and/or (ii) determine, based upon the error rate difference, a second comparison result indicative of whether the error rate difference is potentially problematic. Alternatively, and/or additionally, the evaluation module 110 may (i) compare a packet loss indicated by the second set of service performance indicators with a reference packet loss indicated by the third set of service performance indicators to determine a packet loss difference, and/or (ii) determine, based upon the packet loss difference, a third comparison result indicative of whether the packet loss difference is potentially problematic.

In some examples, an evaluation result 115 of the service performance evaluation is generated based upon (i) one or more performance indicator differences determined via the service performance evaluation (e.g., the traffic volume difference, the error rate difference, the packet loss difference, etc.), (ii) a first quantity of comparison results of the service performance evaluation that are indicative of potentially problematic differences, (iii) a second quantity of comparison results of the service performance evaluation that are not indicative of potentially problematic differences, and/or (iv) a proportion of comparison results, of the service performance evaluation, that are indicative of potentially problematic differences (e.g., the first quantity of comparison results divided by a total quantity of comparison results of the service performance evaluation).

In an example, the evaluation module 110 may generate the evaluation result 115 to be indicative of a positive evaluation result that indicates the third NF device is successfully validated based upon (i) the first quantity of comparison results being less than a first threshold quantity of comparison results, (ii) the second quantity of comparison results being greater than a second threshold quantity of comparison results, and/or (iii) the proportion being less than a threshold proportion. In some examples, in response to the service performance evaluation providing the positive evaluation result, the evaluation module 110 may update the third validation status to be indicative of validated status (e.g., the evaluation module 110 may modify the third validation status from non-validated status to validated status). For example, the evaluation module 110 may provide a validation success indication 111 to the data store 114 to modify the third validation status from non-validated status to validated status.

Alternatively, and/or additionally, the evaluation module 110 may generate the evaluation result 115 to be indicative of a negative evaluation result that indicates the third NF device is not successfully validated based upon (i) the first quantity of comparison results being greater than the first threshold quantity of comparison results, (ii) the second quantity of comparison results being less than the second threshold quantity of comparison results, and/or (iii) the proportion being greater than the threshold proportion.

The evaluation module 110 may perform the service performance evaluation and/or generate the evaluation result 115 using a plurality of validated NF devices (e.g., an aggregation of the plurality of validated NF devices) comprising the first validated NF device and one or more other validated NF devices. For example, the validated NF device selection module 108 may select the plurality of validated NF devices (for use in the service performance evaluation) from the set of candidate NF devices. In some examples, each NF device of one, some or all of the plurality of validated NF devices may be selected (by the validated NF device selection module 108, for example) using one, some or all of the techniques provided herein with respect to the selecting the first validated NF device (for use in the service performance evaluation).

In some examples, the validated NF device selection module 108 may generate a reference service performance profile based upon service performance profiles associated with the plurality of validated NF devices. For example, the reference service performance profile may be generated based upon the fourth service performance profile associated with the first validated NF device and/or one or more other service performance profiles associated with the one or more other validated NF devices. For example, service performance indicators associated with the plurality of validated NF devices may be aggregated to generate an aggregated performance indicator for inclusion in the reference service performance profile. In some examples, service performance indicators of the third service performance profile (associated with the third NF device) may be compared with aggregate service performance indicators indicated by the reference service performance profile to determine the evaluation result 115. In some examples, an aggregation method implemented by the evaluation module 110 to generate the evaluation result 115 may comprise (i) taking an average of a service performance indicator to generate a reference service performance metric (e.g., the reference service performance profile may be indicative of an average of traffic volume metrics associated with the plurality of validated NF devices), (ii) taking a median of a service performance indicator to generate a reference service performance metric (e.g., the reference service performance profile may be indicative of a median of traffic volume metrics associated with the plurality of validated NF devices), and/or (iii) one or more other aggregation methods.

In some examples, the service performance evaluation may comprise a comparative analysis of network activity of the third NF device during the time window with an aggregation of network activity of the plurality of validated NF devices during the time window. For example, the service performance evaluation may comprise comparing the second set of service performance indicators (e.g., a second set of one or more service performance indicators) indicated by the third service performance profile with a reference set of service performance indicators (e.g., a reference set of one or more service performance indicators) indicated by the reference service performance profile. In some examples, the second set of performance indicators and the reference set of service performance indicators are associated with the time window. Alternatively, and/or additionally, the reference set of performance indicators may comprise aggregations (e.g., average, mean, etc.) of service performance indicators derived from (and/or indicative of) network activity of the plurality of validated NF devices during the time window. In some examples, the service performance evaluation may comprise a Kolmogorov-Smirnov test (and/or other type of test) performed using the second set of performance indicators and/or the reference set of service performance indicators.

In an example, for each service performance indicator of one, some or all of the second set of service performance indicators, the evaluation module 110 may (i) compare the service performance indicator with a reference service performance indicator of the reference set of service performance indicators to determine a difference between the service performance indicator and the reference service performance indicator, and/or (ii) determine, based upon the difference, a comparison result indicative of whether the difference between the service performance indicator and the reference service performance indicator is potentially problematic (e.g., indicative of a potential service performance issue). In an example, the evaluation module 110 may compare the difference with a threshold difference, and/or determine whether the difference is potentially problematic based upon whether the difference meets the threshold difference. Alternatively, and/or additionally, the evaluation module 110 may (i) perform the Kolmogorov-Smirnov test (and/or other type of test) based upon the service performance indicator and the reference service performance indicator to determine a second probability that the service performance indicator is significantly different from the reference service performance indicator and/or (ii) compare the second probability with a threshold probability, and/or (iii) determine whether the difference between the service performance indicator and the reference service performance is potentially problematic based upon whether the second probability meets the threshold probability.

In an example, the evaluation module 110 may (i) compare a traffic volume metric (e.g., the first traffic volume metric) of the second set of service performance indicators with a reference traffic volume metric (e.g., an aggregation of traffic volume metrics associated with the plurality of validated NF devices) of the reference set of service performance indicators to determine a traffic volume difference, and/or (ii) determine, based upon the traffic volume difference, a fourth comparison result indicative of whether the traffic volume difference is potentially problematic. In an example, the evaluation module 110 may determine that the traffic volume difference is potentially problematic based upon a determination that the traffic volume difference meets (e.g., exceeds) a threshold traffic volume difference. In an example, the evaluation module 110 may determine that the traffic volume difference is not potentially problematic based upon a determination that the traffic volume difference does not meet (e.g., is less than) the threshold traffic volume difference. Alternatively, and/or additionally, the evaluation module 110 may (i) compare an error rate indicated by the second set of service performance indicators with a reference error rate (e.g., an aggregation of error rates associated with the plurality of validated NF devices) indicated by the reference set of service performance indicators to determine an error rate difference, and/or (ii) determine, based upon the error rate difference, a fifth comparison result indicative of whether the error rate difference is potentially problematic. Alternatively, and/or additionally, the evaluation module 110 may (i) compare a packet loss indicated by the second set of service performance indicators with a reference packet loss (e.g., an aggregation of packet loss metrics associated with the plurality of validated NF devices) indicated by the third set of service performance indicators to determine a packet loss difference, and/or (ii) determine, based upon the packet loss difference, a sixth comparison result indicative of whether the packet loss difference is potentially problematic.

In some examples, the evaluation result 115 of the service performance evaluation is generated based upon (i) one or more performance indicator differences determined via the service performance evaluation (e.g., the traffic volume difference, the error rate difference, the packet loss difference, etc.), (ii) a third quantity of comparison results of the service performance evaluation that are indicative of potentially problematic differences, (iii) a fourth quantity of comparison results of the service performance evaluation that are not indicative of potentially problematic differences, and/or (iv) a proportion of comparison results, of the service performance evaluation, that are indicative of potentially problematic differences (e.g., the third quantity of comparison results divided by a total quantity of comparison results of the service performance evaluation).

In some examples, in response to the service performance evaluation providing the negative evaluation result (e.g., “Validation Failure 113” in FIG. 1), the evaluation module 110 triggers self-remediation device 112 to address a service performance issue associated with the third NF device.

In some examples, the self-remediation device 112 may facilitate one or more second corrective actions to address (e.g., solve) the service performance issue. In some examples, the evaluation module 110 provides the self-remediation device 112 with evaluation information (e.g., evaluation feedback) determined via the service performance evaluation (e.g., the information may be indicative of the negative evaluation result, the service performance issue, and/or one or more service performance indicators associated with the third NF device). In some examples, the self-remediation device 112 may determine the service performance issue and/or the one or more second corrective actions based upon the evaluation information. The one or more second corrective actions may comprise one or more actions to improve service performance associated with the third NF device. The one or more second corrective actions may comprise one, some and/or all of the actions provided herein with respect to the one or more first corrective actions performed to address a service performance issue associated with the third NF device. The one or more second corrective actions may be performed using one or more of the techniques provided herein with respect to performing the one or more first corrective actions. Accordingly, in some examples, the one or more second corrective actions may improve service performance of the third NF device, and thus may address (e.g., solve) the service performance issue. In some examples, in response to performing the one or more second corrective actions, a second service performance evaluation may be triggered and/or performed for the third NF device.

In some examples, the validation system 101 may comprise a notification service 116 for providing notifications (e.g., email notifications, text notifications, etc.) and/or reports associated with service performance evaluations performed using the validation system 101. In some examples, the evaluation module 110 may provide the evaluation result 115 indicative of the result of the service performance evaluation to the notification service 116.

The evaluation module 110 may generate an evaluation report based upon the information 115. In some examples, the evaluation report may be indicative of whether the evaluation result 115 is a positive evaluation result (e.g., validation success) or a negative evaluation result (e.g., validation failure). In some examples, the evaluation report may be indicative of (i) one or more performance indicator differences determined via the service performance evaluation (e.g., the traffic volume difference, the error rate difference, the packet loss difference, etc.), (ii) the third quantity of comparison results (associated with potentially problematic differences, for example), (iii) the fourth quantity of comparison results (not associated with potentially problematic differences, for example), (iv) the proportion, and/or (v) one or more representations (e.g., graphical representations, charts, etc.) of performance indicator trend-lines associated with the third NF device and/or the first validated NF device (e.g., a performance indicator trend-line may be indicative of values of a performance indicator associated with the third NF device and/or the first validated NF device throughout the time window, for example).

In some examples, the evaluation report may comprise a comparative analysis data structure (e.g., a comparative analysis table) indicative of (i) the time window, (ii) a distribution of probabilities (e.g., the first probability, the second probability, and/or other probabilities) over the time window, wherein each of the probabilities corresponds to a probability (determined via Kolmogorov-Smirnov test and/or other type of test, for example) that there is a significant difference between a performance indicator value (e.g., traffic volume metric, error rate metric, packet loss metric, etc.) of the third NF device and the performance indicator value of the first validated NF device, (iii) a distribution of performance indicator differences (e.g., traffic volume differences, error rate differences, packet loss differences, etc.) over the time window, and/or (iv) mean, median, standard deviation, and/or other combinations of performance indicator values associated with the third NF device and/or the first validated NF device.

In some examples, the notification service 116 transmits a first notification (e.g., email notification, text notification, push notification, etc.) to a network management agent (e.g., a technician, an engineer, etc. tasked with managing NF devices). In some examples, the first notification may be indicative of the third NF device, the first validated NF device, the evaluation result 115 (e.g., validation success or failure) and/or the time window. Alternatively, and/or additionally, the first notification may comprise the evaluation report. In an example in which the first notification comprises an email notification, at least a portion of the evaluation report may be included in an email body of the email notification and/or at least a portion of the evaluation report may be included as an attachment to the email notification. Alternatively, and/or additionally, the first notification may comprise a link (e.g., a Uniform Resource Locator (URL)) directed to an internet resource (e.g., a web page, a mobile application, a web application, etc.) that provides the evaluation report. For example, the internet resource may provide a validation interface (e.g., a validation dashboard) that provides the network management agent with access to the evaluation report associated with the third NF device.

In an example, for each performance indicator of a plurality of performance indicators (e.g., traffic volume metric, error rate metric, packet loss metric, etc.), the evaluation report may comprise (i) performance indicator trend-lines associated with the third NF device and/or the first validated NF device throughout the time window, (ii) a distribution of probabilities (e.g., the first probability, the second probability and/or other probabilities) over the time window, (iii) a distribution of performance indicator differences over the time window, and/or (iv) mean, median, standard deviation, and/or other combinations of performance indicator values associated with the third NF device and/or the first validated NF device.

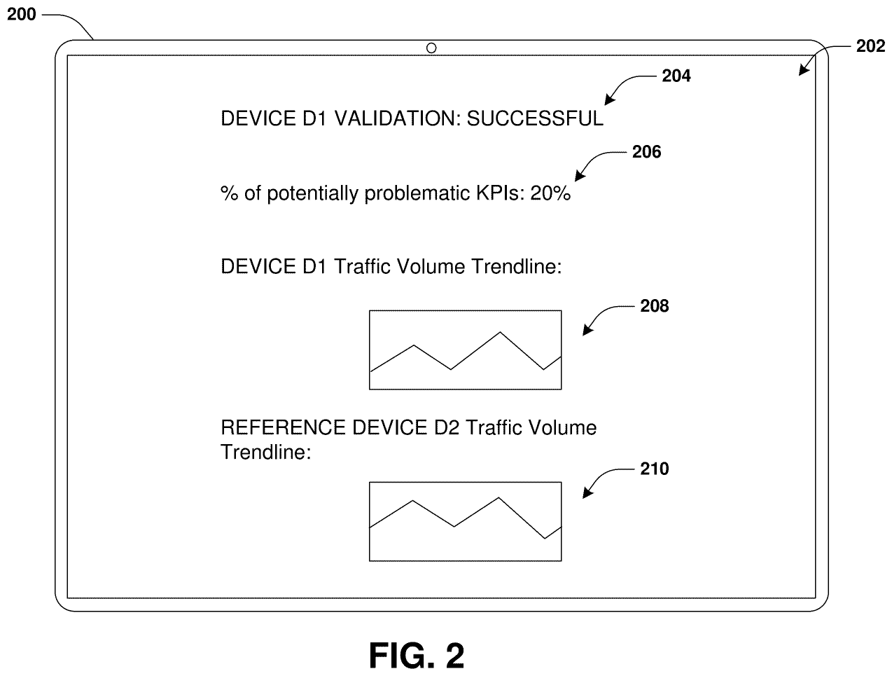

FIG. 2 illustrates an example of the validation interface (shown with reference number 202) displaying a representation of the evaluation report on User Equipment (UE) 200 (e.g., at least one of a phone, a laptop, a tablet, etc.). In some examples, the notification service 116 may provide the evaluation report to the UE 200 for presentation via the validation interface 202. The evaluation report may include (i) an indication 204 of the evaluation result 115 (e.g., validation success), (ii) an indication 206 of the proportion (e.g., 20% of comparison results, of the service performance evaluation, are indicative of potentially problematic differences), (iii) a representation 208 of a first traffic volume trend-line indicative of traffic volume metrics associated with the third NF device (e.g., DEVICE D1) throughout the time window, (iv) a representation 210 of a second traffic volume trend-line indicative of traffic volume metrics associated with the first validated NF device (e.g., DEVICE D2) throughout the time window, (v) a representation (not shown) of a deviation trend-line indicative of differences between traffic volume metrics associated with the third NF device and traffic volume metrics associated with the first validated NF device throughout the time window, and/or (vi) one or more representations of one or more other service performance indicator trend-lines and/or one or more other deviation trend-lines.

In some examples, in response to determining that the third NF device is not ready for evaluation and/or the third NF device being on the evaluation waitlist for longer than a threshold duration (and/or in response to storing the information 107 in the data store 114), the notification service 116 of the validation system 101 may (i) retrieve information 117 (e.g., the third service performance profile and/or the information 107) from the data store 114, (ii) use the information 117 to generate a second notification (e.g., email notification, text notification, push notification, etc.), and/or (iii) transmit the second notification to the network management agent. In some examples, the second notification may be indicative of the third NF device, the first validated NF device, the time window and/or a reason why the third NF device is not ready for evaluation (e.g., service performance issue, insufficient data, the first traffic volume metric associated with the third NF device not meeting the first threshold traffic volume metric, etc.).

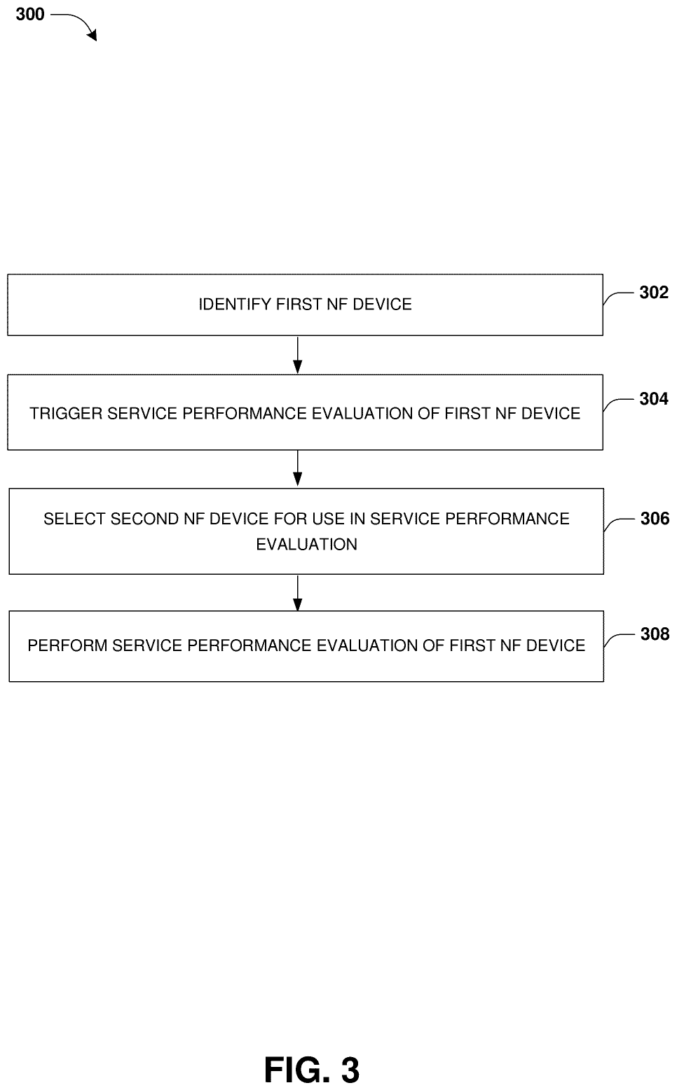

An embodiment of validating NF devices is illustrated by an example method 300 of FIG. 3, and is further described in conjunction with FIG. 1. At 302, the validation system 101 may identify a first NF device (e.g., the third NF device). The first NF device may be associated with a first validation status indicative of non-validated status. At 304, the validation system 101 may trigger a service performance evaluation of the first NF device. At 306, the validation system 101 may select a second NF device (e.g., the first validated NF device) for use in the service performance evaluation of the first NF device. At 308, the validation system 101 may perform the service performance evaluation of the first NF device. For example, the validation system 101 may perform the service performance evaluation using one or more of the techniques provided herein with respect to performing the service performance evaluation of the third NF device. For example, the service performance evaluation may be performed based upon a first service performance profile (e.g., the third service performance profile) associated with the first NF device and/or a second service performance profile (e.g., the fourth service performance profile) associated with the second NF device.

In some examples, each traffic volume metric of one, some or all traffic volume metrics of the present disclosure may be indicative of (i) a user volume metric, such as at least one of a measure (e.g., quantity) of active users of an NF device, a measure (e.g., quantity) of concurrent users of the NF device, a measure (e.g., quantity) of subscribers and/or registered users on the network, etc., (ii) a data transmission volume metric, such as at least one of a data volume (e.g., a total amount of data transmitted by and/or to the NF device over a given period of time, such as the time window), a data rate (e.g., a speed with which data is transmitted by and/or to the NF device), a data throughput, etc., (iii) a NF device utilization metric, such as at least one of a network load (e.g., a proportion of capacity of the NF device being used), a bandwidth utilization metric, etc., and/or (iv) one or more other types of metrics associated with the NF device.

In some examples, each service performance issue of one, some or all service performance issues of the present disclosure may be associated with at least one of (i) anomalous behavior, such as unexpected and/or atypical traffic patterns (e.g., traffic spike, traffic drop, unusual traffic routes, irregular data patterns, etc.), unexpected and/or atypical latency, unexpected and/or atypical resource consumption, unexpected and/or atypical rebooting, etc., (ii) a packet loss issue (e.g., loss of data packets during transmission, which may result in incomplete and/or corrupted data reaching a destination, (iii) a latency issue, (iv) jitter, (v) congestion, (vi) throughput degradation, (vii) interference, (viii) signal degradation, (ix) device overheating, (x) routing issues, (xi) Quality of Service (QoS) failure, (xii) protocol mismatches, (xiii) firmware and/or software bugs, (xiv) security breaches, (xv) power supply failure, (xvi) configuration error (e.g., incorrect settings and/or misconfiguration of a NF device), and/or (xvii) one or more other types of service performance issues.

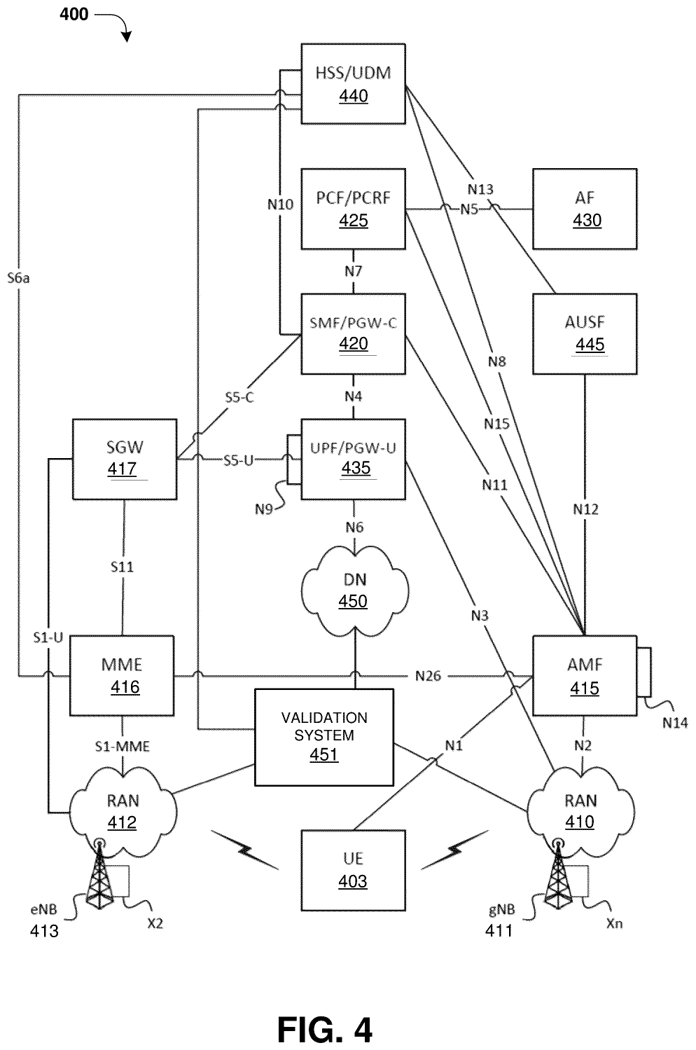

FIG. 4 illustrates an example environment 400, in which one or more embodiments may be implemented. In some embodiments, environment 400 may correspond to a Fifth Generation (“5G”) network, and/or may include elements of a 5G network. In some embodiments, environment 400 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 400 may include UE 403, RAN 410 (which may include one or more Next Generation Node Bs (“gNBs”) 411), RAN 412 (which may include one or more one or more evolved Node Bs (“eNBs”) 413), and various network functions such as Access and Mobility Management Function (“AMF”) 415, Mobility Management Entity (“MME”) 416, Serving Gateway (“SGW”) 417, Session Management Function (“SMF”)/Packet Data Network (“PDN”) Gateway (“PGW”)-Control plane function (“PGW-C”) 420, Policy Control Function (“PCF”)/Policy Charging and Rules Function (“PCRF”) 425, Application Function (“AF”) 430, User Plane Function (“UPF”)/PGW-User plane function (“PGW-U”) 435, Home Subscriber Server (“HSS”)/Unified Data Management (“UDM”) 440, and Authentication Server Function (“AUSF”) 445. Environment 400 may also include one or more networks, such as Data Network (“DN”) 450. Environment 400 may include one or more additional devices or systems communicatively coupled to one or more networks (e.g., DN 450), such as emergency system 451.

The example shown in FIG. 4 illustrates one instance of each network component or function (e.g., one instance of SMF/PGW-C 420, PCF/PCRF 425, UPF/PGW-U 435, HSS/UDM 440, and/or 445). In practice, environment 400 may include multiple instances of such components or functions. For example, in some embodiments, environment 400 may include multiple “slices” of a core network, where each slice includes a discrete set of network functions (e.g., one slice may include a first instance of SMF/PGW-C 420, PCF/PCRF 425, UPF/PGW-U 435, HSS/UDM 440, and/or 445, while another slice may include a second instance of SMF/PGW-C 420, PCF/PCRF 425, UPF/PGW-U 435, HSS/UDM 440, and/or 445). The different slices may provide differentiated levels of service, such as service in accordance with different Quality of Service (“QoS”) parameters.

The quantity of devices and/or networks, illustrated in FIG. 4, is provided for explanatory purposes only. In practice, environment 400 may include additional devices and/or networks, fewer devices and/or networks, different devices and/or networks, or differently arranged devices and/or networks than illustrated in FIG. 4. For example, while not shown, environment 400 may include devices that facilitate or enable communication between various components shown in environment 400, such as routers, modems, gateways, switches, hubs, etc. Alternatively, and/or additionally, one or more of the devices of environment 400 may perform one or more network functions described as being performed by another one or more of the devices of environment 400. Devices of environment 400 may interconnect with each other and/or other devices via wired connections, wireless connections, or a combination of wired and wireless connections. In some implementations, one or more devices of environment 400 may be physically integrated in, and/or may be physically attached to, one or more other devices of environment 400.

UE 403 may include a computation and communication device, such as a wireless mobile communication device that is capable of communicating with RAN 410, RAN 412, and/or DN 450. UE 403 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 403 may send traffic to and/or receive traffic (e.g., user plane traffic) from DN 450 via RAN 410, RAN 412, and/or UPF/PGW-U 435.

RAN 410 may be, or may include, a 5G RAN that includes one or more base stations (e.g., one or more gNBs 411), via which UE 403 may communicate with one or more other elements of environment 400. UE 403 may communicate with RAN 410 via an air interface (e.g., as provided by gNB 411). For instance, RAN 410 may receive traffic (e.g., voice call traffic, data traffic, messaging traffic, signaling traffic, etc.) from UE 403 via the air interface, and may communicate the traffic to UPF/PGW-U 435, and/or one or more other devices or networks. Similarly, RAN 410 may receive traffic intended for UE 403 (e.g., from UPF/PGW-U 435, AMF 415, and/or one or more other devices or networks) and may communicate the traffic to UE 403 via the air interface.

RAN 412 may be, or may include, a LTE RAN that includes one or more base stations (e.g., one or more eNBs 413), via which UE 403 may communicate with one or more other elements of environment 400. UE 403 may communicate with RAN 412 via an air interface (e.g., as provided by eNB 413). For instance, RAN 410 may receive traffic (e.g., voice call traffic, data traffic, messaging traffic, signaling traffic, etc.) from UE 403 via the air interface, and may communicate the traffic to UPF/PGW-U 435, and/or one or more other devices or networks. Similarly, RAN 410 may receive traffic intended for UE 403 (e.g., from UPF/PGW-U 435, SGW 417, and/or one or more other devices or networks) and may communicate the traffic to UE 403 via the air interface.

AMF 415 may include one or more devices, systems, Virtualized Network Functions (“VNFs”), etc., that perform operations to register UE 403 with the 5G network, to establish bearer channels associated with a session with UE 403, to hand off UE 403 from the 5G network to another network, to hand off UE 403 from the other network to the 5G network, manage mobility of UE 403 between RANs 410 and/or gNBs 411, and/or to perform other operations. In some embodiments, the 5G network may include multiple AMFs 415, which communicate with each other via the N14 interface (denoted in FIG. 4 by the line marked “N14” originating and terminating at AMF 415).

MME 416 may include one or more devices, systems, VNFs, etc., that perform operations to register UE 403 with the EPC, to establish bearer channels associated with a session with UE 403, to hand off UE 403 from the EPC to another network, to hand off UE 403 from another network to the EPC, manage mobility of UE 403 between RANs 412 and/or eNBs 413, and/or to perform other operations.

SGW 417 may include one or more devices, systems, VNFs, etc., that aggregate traffic received from one or more eNBs 413 and send the aggregated traffic to an external network or device via UPF/PGW-U 435. Additionally, SGW 417 may aggregate traffic received from one or more UPF/PGW-Us 435 and may send the aggregated traffic to one or more eNBs 413. SGW 417 may operate as an anchor for the user plane during inter-eNB handovers and as an anchor for mobility between different telecommunication networks or RANs (e.g., RANs 410 and 412).

SMF/PGW-C 420 may include one or more devices, systems, VNFs, etc., that gather, process, store, and/or provide information in a manner described herein. SMF/PGW-C 420 may, for example, facilitate in the establishment of communication sessions on behalf of UE 403. In some embodiments, the establishment of communications sessions may be performed in accordance with one or more policies provided by PCF/PCRF 425.

PCF/PCRF 425 may include one or more devices, systems, VNFs, etc., that aggregate information to and from the 5G network and/or other sources. PCF/PCRF 425 may receive information regarding policies and/or subscriptions from one or more sources, such as subscriber databases and/or from one or more users (such as, for example, an administrator associated with PCF/PCRF 425).

AF 430 may include one or more devices, systems, VNFs, etc., that receive, store, and/or provide information that may be used in determining parameters (e.g., quality of service parameters, charging parameters, or the like) for certain applications.

UPF/PGW-U 435 may include one or more devices, systems, VNFs, etc., that receive, store, and/or provide data (e.g., user plane data). For example, UPF/PGW-U 435 may receive user plane data (e.g., voice call traffic, data traffic, etc.), destined for UE 403, from DN 450, and may forward the user plane data toward UE 403 (e.g., via RAN 410, SMF/PGW-C 420, and/or one or more other devices). In some embodiments, multiple UPFs 435 may be deployed (e.g., in different geographical locations), and the delivery of content to UE 403 may be coordinated via the N9 interface (e.g., as denoted in FIG. 4 by the line marked “N9” originating and terminating at UPF/PGW-U 435). Similarly, UPF/PGW-U 435 may receive traffic from UE 403 (e.g., via RAN 410, SMF/PGW-C 420, and/or one or more other devices), and may forward the traffic toward DN 450. In some embodiments, UPF/PGW-U 435 may communicate (e.g., via the N4 interface) with SMF/PGW-C 420, regarding user plane data processed by UPF/PGW-U 435.

HSS/UDM 440 and AUSF 445 may include one or more devices, systems, VNFs, etc., that manage, update, and/or store, in one or more memory devices associated with AUSF 445 and/or HSS/UDM 440, profile information associated with a subscriber. AUSF 445 and/or HSS/UDM 440 may perform authentication, authorization, and/or accounting operations associated with the subscriber and/or a communication session with UE 403.

DN 450 may include one or more wired and/or wireless networks. For example, DN 450 may include an Internet Protocol (“IP”)-based PDN, a wide area network (“WAN”) such as the Internet, a private enterprise network, and/or one or more other networks. UE 403 may communicate, through DN 450, with data servers, other UEs UE 403, and/or to other servers or applications that are coupled to DN 450. DN 450 may be connected to one or more other networks, such as a public switched telephone network (“PSTN”), a public land mobile network (“PLMN”), and/or another network. DN 450 may be connected to one or more devices, such as content providers, applications, web servers, and/or other devices, with which UE 403 may communicate.

The validation system 451 may include one or more devices, systems, VNFs, etc., that perform one, some and/or all operations described herein. For example, the validation system 451 may automatically discover and/or identify an NF device, and/or may automatically perform a service performance evaluation to validate the NF device.

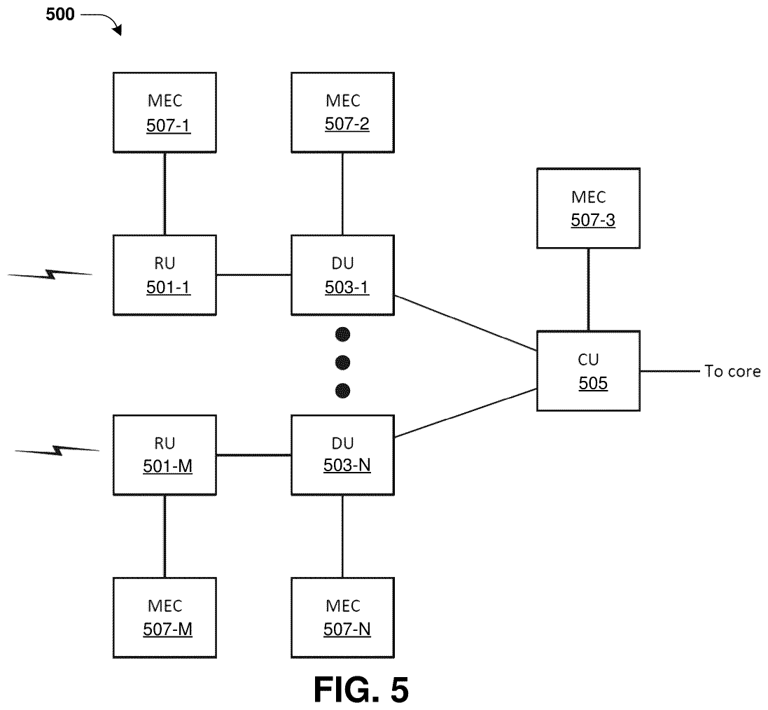

FIG. 5 illustrates an example Distributed Unit (“DU”) network 500, which may be included in and/or implemented by one or more RANs (e.g., RAN 410, RAN 412, or some other RAN). In some embodiments, a particular RAN may include one DU network 500. In some embodiments, a particular RAN may include multiple DU networks 500. In some embodiments, DU network 500 may correspond to a particular gNB 411 of a 5G RAN (e.g., RAN 410). In some embodiments, DU network 500 may correspond to multiple gNBs 411. In some embodiments, DU network 500 may correspond to one or more other types of base stations of one or more other types of RANs. As shown, DU network 500 may include Central Unit (“CU”) 505, one or more Distributed Units (“DUs”) 503-1 through 503-N (referred to individually as “DU 503,” or collectively as “DUs 503”), and one or more Radio Units (“RUs”) 501-1 through 501-M (referred to individually as “RU 501,” or collectively as “RUs 501”).

CU 505 may communicate with a core of a wireless network (e.g., may communicate with one or more of the devices or systems described above with respect to FIG. 4, such as AMF 415 and/or UPF/PGW-U 435). In the uplink direction (e.g., for traffic from UEs UE 403 to a core network), CU 505 may aggregate traffic from DUs 503, and forward the aggregated traffic to the core network. In some embodiments, CU 505 may receive traffic according to a given protocol (e.g., Radio Link Control (“RLC”)) from DUs 503, and may perform higher-layer processing (e.g., may aggregate/process RLC packets and generate Packet Data Convergence Protocol (“PDCP”) packets based upon the RLC packets) on the traffic received from DUs 503.

In accordance with some embodiments, CU 505 may receive downlink traffic (e.g., traffic from the core network) for a particular UE 403, and may determine which DU(s) 503 should receive the downlink traffic. DU 503 may include one or more devices that transmit traffic between a core network (e.g., via CU 505) and UE 403 (e.g., via a respective RU 501). DU 503 may, for example, receive traffic from RU 501 at a first layer (e.g., physical (“PHY”) layer traffic, or lower PHY layer traffic), and may process/aggregate the traffic to a second layer (e.g., upper PHY and/or RLC). DU 503 may receive traffic from CU 505 at the second layer, may process the traffic to the first layer, and provide the processed traffic to a respective RU 501 for transmission to UE 403.

RU 501 may include hardware circuitry (e.g., one or more RF transceivers, antennas, radios, and/or other suitable hardware) to communicate wirelessly (e.g., via an RF interface) with one or more UEs UE 403, one or more other DUs 503 (e.g., via RUs 501 associated with DUs 503), and/or any other suitable type of device. In the uplink direction, RU 501 may receive traffic from UE 403 and/or another DU 503 via the RF interface and may provide the traffic to DU 503. In the downlink direction, RU 501 may receive traffic from DU 503, and may provide the traffic to UE 403 and/or another DU 503.

RUs 501 may, in some embodiments, be communicatively coupled to one or more Multi-Access/Mobile Edge Computing (“MEC”) devices, referred to sometimes herein simply as (“MECs”) 507. For example, RU 501-1 may be communicatively coupled to MEC 507-1, RU 501-M may be communicatively coupled to MEC 507-M, DU 503-1 may be communicatively coupled to MEC 507-2, DU 503-N may be communicatively coupled to MEC 507-N, CU 505 may be communicatively coupled to MEC 507-3, and so on. MECs 507 may include hardware resources (e.g., configurable or provisionable hardware resources) that may be configured to provide services and/or otherwise process traffic to and/or from UE 403, via a respective RU 501.

For example, RU 501-1 may route some traffic, from UE 403, to MEC 507-1 instead of to a core network (e.g., via DU 503 and CU 505). MEC 507-1 may process the traffic, perform one or more computations based upon the received traffic, and may provide traffic to UE 403 via RU 501-1. In this manner, ultra-low latency services may be provided to UE 403, as traffic does not need to traverse DU 503, CU 505, and an intervening backhaul network between DU network 500 and the core network. In some embodiments, MEC 507 may include, and/or may implement some or all of the functionality described above with respect to at least one of the validation system 451, the validation system 101, the method 300, etc.

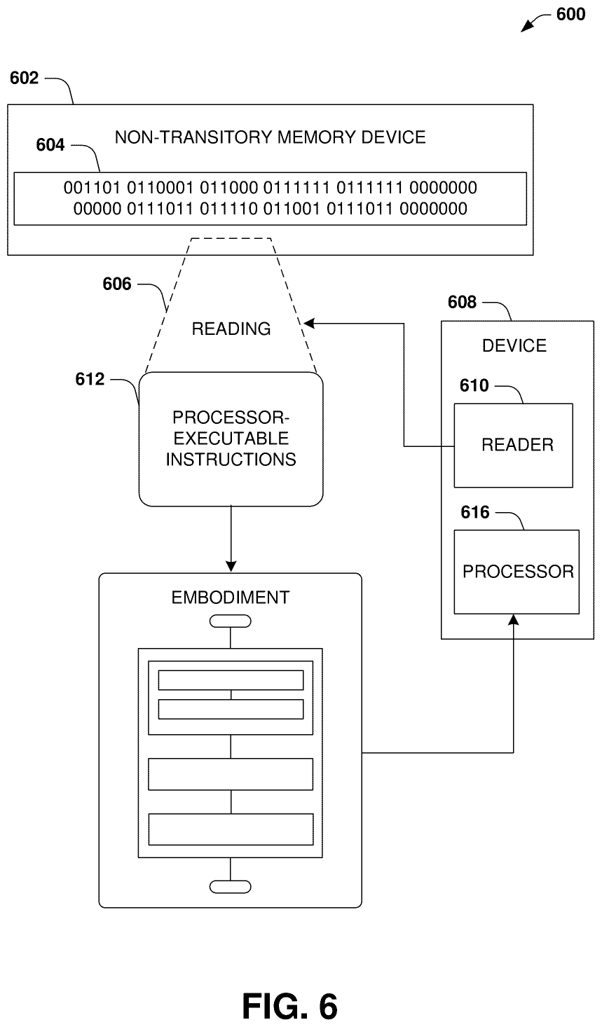

FIG. 6 is an illustration of a scenario 600 involving an example non-transitory machine-readable medium 602. The non-transitory machine-readable medium 602 may comprise processor-executable instructions 612 that when executed by a processor 616 cause performance (e.g., by the processor 616) of at least some of the provisions herein. The non-transitory machine-readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 300 of FIG. 3, for example. In some embodiments, the processor-executable instructions 612 are configured to cause implementation of a system, such as at least some of the example validation system 101 of FIG. 1, for example.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
identifying a first network function (NF) device associated with a first validation status indicative of non-validated status;
triggering a service performance evaluation of the first NF device;
selecting a second NF device for use in the service performance evaluation of the first NF device, wherein the second NF device is associated with a second validation status indicative of validated status; and
performing the service performance evaluation of the first NF device based upon a first service performance profile associated with the first NF device and a second service performance profile associated with the second NF device.

2. The method of claim 1, comprising:
in response to the service performance evaluation providing a positive evaluation result, updating the first validation status to be indicative of validated status.

3. The method of claim 1, comprising:
in response to the service performance evaluation providing a negative evaluation result, triggering a self-remediation device to address a service performance issue associated with the first NF device.

4. The method of claim 1, comprising:
generating an evaluation report based upon an evaluation result of the service performance evaluation; and
providing the evaluation report to user equipment (UE) for display.

5. The method of claim 1, comprising:
monitoring network activity of a network;
detecting an addition of the first NF device to the network; and
setting the first validation status associated with the first NF device to the non-validated status based upon a determination that the first NF device was not successfully validated since the addition of the first NF device to the network.

6. The method of claim 1, comprising:
detecting a service performance issue associated with the first NF device; and
setting the first validation status associated with the first NF device to the non-validated status based upon the service performance issue.

7. The method of claim 1, comprising:
comparing a traffic volume metric associated with the first NF device with a threshold traffic volume metric, wherein the service performance evaluation is at least one of triggered or performed in response to a determination that the traffic volume metric meets the threshold traffic volume metric.

8. The method of claim 1, comprising:
determining whether the first NF device is associated with normalized service performance, wherein the service performance evaluation is at least one of triggered or performed in response to a determination that the first NF device is associated with normalized service performance.

9. The method of claim 1, comprising:
determining a first geolocation associated with the first NF device; and
determining a second geolocation associated with the second NF device, wherein the second NF device is selected for use in the service performance evaluation of the first NF device in response to determining that the second NF device is within a proximity of the first NF device based upon the first geolocation and the second geolocation.

10. The method of claim 1, comprising:
determining a device type of the first NF device, wherein the service performance evaluation is performed based upon the device type.

11. A non-transitory computer-readable medium storing instructions that when executed perform operations comprising:
identifying a first network function (NF) device associated with a first validation status indicative of non-validated status;
triggering a service performance evaluation of the first NF device;
selecting a second NF device for use in the service performance evaluation of the first NF device, wherein the second NF device is associated with a second validation status indicative of validated status; and
performing the service performance evaluation of the first NF device based upon a first service performance profile associated with the first NF device and a second service performance profile associated with the second NF device.

12. The non-transitory computer-readable medium of claim 11, the operations comprising:
in response to the service performance evaluation providing a positive evaluation result, updating the first validation status to be indicative of validated status.

13. The non-transitory computer-readable medium of claim 11, the operations comprising:
in response to the service performance evaluation providing a negative evaluation result, triggering a self-remediation device to address a service performance issue associated with the first NF device.

14. The non-transitory computer-readable medium of claim 11, the operations comprising:
generating an evaluation report based upon an evaluation result of the service performance evaluation; and
providing the evaluation report to user equipment (UE) for display.

15. The non-transitory computer-readable medium of claim 11, the operations comprising:
monitoring network activity of a network;
detecting an addition of the first NF device to the network; and
setting the first validation status associated with the first NF device to the non-validated status based upon a determination that the first NF device was not successfully validated since the addition of the first NF device to the network.

16. The non-transitory computer-readable medium of claim 11, the operations comprising:
detecting a service performance issue associated with the first NF device; and
setting the first validation status associated with the first NF device to the non-validated status based upon the service performance issue.

17. The non-transitory computer-readable medium of claim 11, the operations comprising:
comparing a traffic volume metric associated with the first NF device with a threshold traffic volume metric, wherein the service performance evaluation is at least one of triggered or performed in response to a determination that the traffic volume metric meets the threshold traffic volume metric.

18. The non-transitory computer-readable medium of claim 11, the operations comprising:
determining whether the first NF device is associated with normalized service performance, wherein the service performance evaluation is at least one of triggered or performed in response to a determination that the first NF device is associated with normalized service performance.

19. A device comprising a processor configured to:
identify a first network function (NF) device associated with a first validation status indicative of non-validated status;
trigger a service performance evaluation of the first NF device;
select a second NF device for use in the service performance evaluation of the first NF device, wherein the second NF device is associated with a second validation status indicative of validated status; and
perform the service performance evaluation of the first NF device based upon a first service performance profile associated with the first NF device and a second service performance profile associated with the second NF device.

20. The device of claim 19, the processor is configured to:
update, in response to the service performance evaluation providing a positive evaluation result, the first validation status to be indicative of validated status.
